(19) United States
(12) Patent Application Publication
(10) Pub. No.: US 2026/0253405 A1
(43) Pub. Date: Aug. 27, 2026

(54) SELF-CLASSIFICATION OF NEURAL NETWORKS

(71) Applicant: EYYES GmbH, Gedersdorf (AT)

(72) Inventors: Johannes Traxler, Imbach (AT); Ilkay Wunderlich, Dresden (DE); Michael Breiter, Herzogenrath (DE)

(21) Appl. No.: 19/648,801

(22) Filed: Apr. 15, 2026

Related U.S. Application Data
(63) Continuation of application No. PCT/EP2024/079286, filed on Oct. 17, 2024.

(30) Foreign Application Priority Data
Oct. 18, 2023 (AT) A 50846/2023

(51) Int. Cl. G06V 10/82; G06T 7/70; G06V 10/74; G06V 10/764; G06V 20/58

(52) U.S. Cl. CPC G06V 10/82; G06T 7/70; G06V 10/761; G06V 10/764; G06T 2207/20084; G06V 20/58

(57) ABSTRACT

A method of classifying objects detected by n (n=2,3…) artificial neural networks in at least one image.

This application is a continuation of International Application PCT/EP2024/079286 filed on October 17, 2024. Thus, all of the subject matter of International Application PCT/EP2024/079286 is incorporated herein by reference.

### BACKGROUND OF THE INVENTION

The method according to the invention can be performed as a computer-implemented method. In particular, the invention disclosed below relates to a method for classifying objects detected by n (n=2,3…) artificial neural networks in at least one image, wherein the objects are detected in the image in a computing unit using the n neural networks and each detected object is assigned to a defined object class or an undefined object class. The image or images can be created by an image sensor.

According to current teaching, an object class is assigned to a detected object from a set of defined object classes using neural networks. A probability can be determined with which probability an object is assigned to the defined object class. The latter can also imply that an object is only assigned to a defined object class with a probability below a threshold value, or otherwise assigned to an undefined object class or none at all.

Furthermore, an IoU value is created for each object detected with each neural network. The creation of an IoU value for an object in an image is known according to current teaching.

The above-mentioned process step (in short) of detecting at least one object and assigning an object class to the object can be carried out according to current teaching by applying known artificial neural networks (hereinafter referred to as neural network or simply network), whereby it is up to the user to select a suitable type of neural network and/or to train the selected neural network.

According to current teaching, CNN, R-CNN, and Deep-CNN, for example, are known as generic names for neural networks and thus as different neural networks. Furthermore, neural networks of one of the aforementioned types can be trained in different ways, so that different neural networks can exist due to the different training of neural networks of a single type. Differently trained networks can have different weighting factors. Different neural networks may therefore exist if neural networks of different types and/or differently trained networks of a single type are used.

According to the state of the art, the types of neural networks and/or the differently trained neural networks deliver different results when analyzing input values such as an image. A different result may be whether objects in the image are recognized or whether different neural networks assign different object classes to a detected object. A different result may also be in the form of different neural networks determining different boundaries or bounding boxes of an object, which can be determined in different IoU values.

If an analysis of the same object by different neural networks leads to different results, it can be assumed that at least one result is incorrect and/or insufficiently accurate.

Unlike the invention disclosed herein, WO2020152627 is based on a pairwise comparison. A pairwise comparison does not involve determining a minimum number of objects with an assigned object class.

WO2020152627 (see in particular ) discloses a method in which N results are generated using a number of N neural networks. The N results are compared in pairs and common numerical values (ensemble scores, plural) are determined. A variance is calculated for this common numerical value in order to determine the suitability of a network based on a variance between the result value determined by this neural network and the common value.

Assuming that an image is analyzed using the method disclosed in WO2020152627 with n=10 neural networks. A common result occurs in two networks. The method disclosed in WO2020152627 would determine the suitability of the eight other neural networks depending on the variance from the common result value of two networks, although the common result of the two neural networks is by no means certain according to the invention disclosed here.

KR20230046028A is based on the creation of shared training images (see KR20230046028A, ). This approach differs fundamentally from the invention disclosed herein.

The document WALAMBR RAHEE et al, “Lightweight Object Detection Ensemble Framework for Autonomous Vehicles in Challenging Weather Conditions,” Computational Intelligence and Neuroscience, Volume 2021, No. 1, and the document GUNDUZ GULTEKIN et al., “Efficient Multi-Object Tracking by Strong Associations on Intelligent Vehicles,” IEEE, Volume 4, No. 3, May 28, 2019, do not disclose any decision criteria for classifying object detection as reliable or unreliable object detection.

For example, when using neural networks to analyze an image captured by a camera mounted on a vehicle, a neural network can pose a certainty risk if it delivers incorrect results.

The invention disclosed herein thus addresses the technical task of providing a method for evaluating the suitability of neural networks for analyzing input data, in particular image data.

### SUMMARY OF THE INVENTION

The invention disclosed herein specifically addresses the technical task of providing a method that can be carried out without high computing power, and therefore on the basis of simple process steps, so that the method can also be applied to image data from a camera mounted on a vehicle. The method according to the invention should also be executable with a mobile computing unit, for example one arranged on the vehicle, whereby computing units on vehicles usually only have low computing power.

In particular, it should be possible to check whether a neural network is suitable for analyzing image data so that the vehicle can be controlled entirely or assisted on the basis of the analysis by the neural network.

According to the invention, the above-mentioned technical problem is solved by the computing unit classifying a detected object as a certain object if the object is assigned to a number of neural networks greater than or equal to a first predetermined value of the same defined object class and which object has an IoU value greater than or equal to a threshold value, and/or the computing unit classifies a detected object as an uncertain object if the object is assigned to the same defined object class by a number of neural networks less than a first predetermined value, or the object is assigned to an undefined object class with a number of neural networks greater than or equal to a second default value, which object has an IoU value less than a threshold value, wherein the first default value and the second default value are less than or equal to the number of neural networks.

The designation of object classes is not regulated by any standard. The above process may require standardization of the designation of object classes in neural networks so that an object is actually assigned to a single object class by the neural networks and this assignment is comparable.

Standardization of object classes may be necessary when comparing neural networks from different developers and determining the suitability of these networks. In neural networks from a single developer, identical object classes from different neural networks usually have a uniform designation.

Objects that are detected by different neural networks and assigned to the same object class using a minimum number of different neural networks are classified as reliable objects (equivalent to reliably detected objects) (criterion 1). The minimum number of neural networks is greater than or equal to the first default value specified by the user. Criterion 1 may also include the determination that the objects are detected with a probability and assigned to an object class, which probability is greater than or equal to a minimum probability.

This means that the objects in the image can be selected for which a subset n≥v of the neural networks deliver the same result.

The criterion of an IuO value exceeding a threshold value is also introduced. Neural networks that deliver an IuO value greater than or equal to a threshold value (criterion 2) are sufficiently accurate with regard to the bounding rectangle.

Those detected objects that meet the above-mentioned criterion 1 and the above-mentioned criterion 2 are classified as certain objects. Detected objects that do not meet at least one criterion from criterion 1 and criterion 2 are classified as uncertain objects (equivalent to uncertain detected objects).

Based on the classification of objects defined above and a selection of certain objects, it is possible to determine which neural networks are suitable for recognizing the object in the image, since these neural networks deliver the same or similar results, particularly with regard to the assignment of object classes, and sufficiently accurate results, particularly with regard to the boundaries. The classification of an object as a certain object is interpreted to mean that the certain object is detected exclusively by suitable or sufficiently accurate neural networks.

A neural network can be considered particularly suitable for analyzing an image if a neural network reliably delivers objects for a defined number of objects from a total number of objects in the image.

The at least one image can be analyzed by two neural networks, whereby at least one object is assigned to at least one object class using the at least two neural networks. In this case, criterion 1 is based on the confirmation of the assignment of an object to an object class based on the application of a neural network by the assignment of the object to the object class based on the application of a further neural network.

The at least one image can be analyzed by at least three neural networks, whereby at least one object is assigned to at least one object class using the at least three neural networks. In this case, criterion 1 is based on the majority confirmation of the assignment of an object to an object class based on the application of a neural network by the assignment of the object to the object class based on the application of further neural networks. Preferably, an odd number of neural networks is applied.

An image is usually the result of capturing an environment with an image sensor and processing the image data created with the image sensor. Since the image data describes the image, the method according to the invention can be applied in an equivalent manner to image data or an image or images or parts of an image. The term “image” used here also includes the image data describing the image.

The environment may be subject to influences. In particular, the selection of objects can be used to determine which neural networks are suitable for analyzing the objects in the environment with their influences and/or from the perspective of the image data processing that has taken place.

In the method according to the invention, objects of a single image can be detected using neural networks. The n neural networks are applied to analyze the same image.

Objects can be detected in several images or in several image sections of an image, wherein the images or image sections comprise at least one object of an object class.

With a number of n images, a single neural network can be applied to the analysis of a single image. Preferably, several neural networks are applied to the analysis of an image. The method according to the invention can be applied in particular to a series of images.

The above-mentioned criteria for classifying the detected objects are easy to implement. Due to this ease of implementation, the method according to the invention is also applicable to a large number of images following immediately one after the other, in particular films.

An object position of the object can be determined in one image, and the objects with a similar object position can be determined in the other images.

Similar positions can be used to ensure that an object contained in several images is entered into the process as a single object. A similar object position can be defined using boundary ranges. A similar object position can also be determined by identifying a trajectory in the images, whereby the object positions covered by a single trajectory are regarded as similar object positions.

An object class may comprise only a single detected object after assignment of an object by a neural network. This can be achieved by sufficiently refining the object classes.

The certain objects and/or the uncertain objects from the set of detected objects in the image can be displayed in a display unit. The display of secure objects and/or insecure objects may also include a display of networks classified as suitable or unsuitable according to the criteria described above.

The certain objects and their object position in the image and/or the uncertain objects and their object position in the image are displayed.

In particular, the object and the object position can be displayed in the image. The certain objects can be marked with a first mark and/or the uncertain objects with a second mark in the image. For example, the boundary surface of an object (bonding box) can be displayed in a first color for a certain object and/or in a second color for an uncertain object. This provides the viewer with real-time information on whether an object is classified as a certain object or an uncertain object.

Objects in the at least one image can be detected using at least three neural networks, whereby links are created between objects of the same known object class detected using different neural networks, the number of links between the individual neural networks is determined, and the suitability of neural networks from the at least three neural networks is indicated by the number of links between the mentioned neural network and the further neural network.

Objects in the at least one image can be detected using at least three neural networks, in which the objects detected using an nth neural network are displayed on an nth segment of an arc-shaped polygon or an arc on a display unit. The objects detected using different neural networks and belonging to the same known object class are connected by lines, and the objects are marked with a number of lines greater than or equal to the predetermined value v. A user can select the displayed objects via an input unit and thus confirm the suitability of the applied neural networks.

This embodiment of the method according to the invention will be discussed below with reference to a figure.

A distinction must be made between the reproduction of information to a user and the technical processing of information described above. In the technical processing described above, data is processed. It is displayed in processed data so that the viewer receives real-time information about the classification of objects as secure objects or insecure objects.

One possible application of the method according to the invention is that a user checks the suitability of the neural networks used during or immediately after the analysis of the image and confirms this suitability. The user then has the option, for example, of deactivating unsuitable neural networks, although the activation or deactivation of the neural networks is not part of the invention. The user makes this selection based on their experience, with the user being supported in this task by the representation described above.

The task assigned to the operator is particularly complex when the analysis of several images, such as a film, is to be evaluated using several neural networks. The above-mentioned links between the images are determined by the lines and consequently also displayed, thereby reducing the complexity of the task.

Complex issues relating to the suitability of neural networks are presented in a simple manner, enabling human-machine interaction for the activation and/or deactivation of the neural networks.

The polygon may have a closed shape with n sides.

The skilled person can combine the above-described proposed solutions with each other.

### BRIEF DESCRIPTION OF THE DRAWINGS

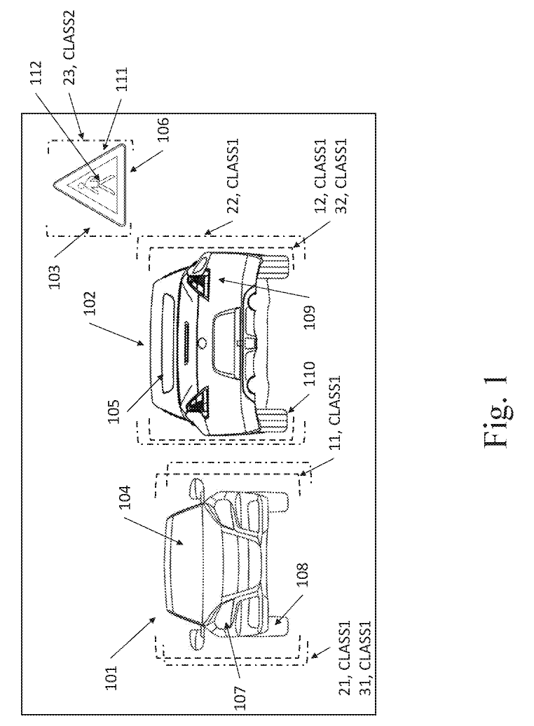

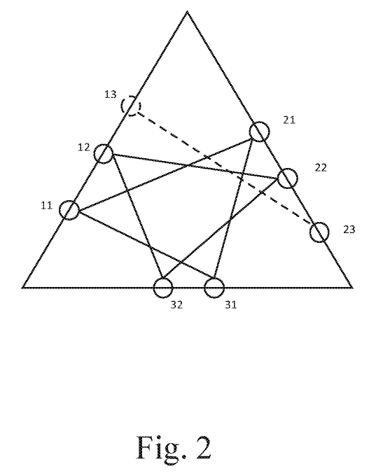

The invention will be further explained below with reference to the drawings, in which: FIG. 1 illustrates a method according to the invention using an example of the image shown in FIG. 1; and FIG. 2 shows a possible graphical representation of the method according to the invention.

### DETAILED DESCRIPTION OF THE INVENTION

The embodiments shown in the figures merely illustrate possible embodiments, whereby it should be noted at this point that the invention is not limited to these specifically illustrated embodiments, but that combinations of the individual embodiments with each other and a combination of an embodiment with the above-mentioned general description are also possible. These further possible combinations do not need to be explicitly mentioned, as they are within the skill of a person skilled in the art based on the teaching of the present invention.

The scope of protection is determined by the claims. However, the description and drawings are to be used to interpret the claims. Individual features or combinations of features from the various embodiments shown and described may represent independent inventive solutions in themselves. The task underlying the independent inventive solutions can be found in the description.

FIG. 1 illustrates the application of the method according to the invention in evaluating the suitability of neural networks for analyzing an image. The suitability of a neural network can be understood to mean that the neural network delivers sufficiently accurate and correct results.

FIG. 1 shows an example of an image of a traffic situation captured by a camera mounted on a vehicle. This image is to be analyzed using neural networks so that objects can subsequently be classified as collision objects or non-collision objects. The basis for recognizing an object as a collision object is the correct and sufficiently accurate recognition of the object using neural networks. The purpose of the invention is to provide a means of evaluating the suitability of the neural networks. It is not the purpose of the invention to analyze objects to determine whether they are actually collision objects.

The solution presented in this disclosure is based on a comparison of the results obtained with the respective neural network, in particular the detection of an object and the assignment of an object class to the object.

Regarding FIG. 1:

The method according to the invention relates to the classification of objects detected by n (n=2,3...) artificial neural networks in at least one image according to a predetermined criterion.

Using a computing unit, the object groups 101, 102, 103 are detected as objects in the image shown in FIG. 1 by applying three different neural networks to the image. Each neural network applied assigns the detected object to an object class from a set of standardized object classes.

Furthermore, an IoU value is determined for each detected object, which IoU value describes the geometric accuracy of the detection performed with each neural network. The determination of the IoU value is known according to current teaching and does not require any special explanation here.

According to current thinking, it can be assumed that the individual neural networks also deliver different results. A different result may be due, for example, to whether an object is detected and, furthermore, to which object class the object is assigned. Furthermore, the neural networks may differ in terms of the geometric boundaries (bounding boxes) they create.

The differences mentioned are particularly crucial for the application of neural networks to traffic situations.

FIG. 1 shows an image with three object groups 101, 102, 103 as objects according to claim 1. The term “object group” is chosen because an object group visible in FIG. 1 is formed from several objects. The method described here and applied to object groups 101, 102, 103 is also applicable to the objects mentioned as examples. The method according to the invention can be refined, for example, by considering objects instead of object groups.

The first object group 101 is formed by a car 104 driving toward the camera. The first object group 1 comprises a headlight 107, a wheel 108, et cetera.

The second object group 102 is formed by a car 105 moving away from the camera. The second object group 102 comprises a rear light 109, a wheel 110, et cetera.

The third object group 103 is formed by a traffic sign 106. The traffic sign 106 comprises the sign defining the outer shape and a symbol.

A first neural network detects the first object group 101 and assigns it an interface 11. The first neural network assigns the object class CLASS1 to the first object group 101.

The first neural network detects the second object group 102 and assigns it an interface 12. The first neural network assigns the object class CLASS1 to the second object group 102.

The first neural network does not detect the third object group 103 with sufficient probability. As is known according to current teaching, neural networks provide an indication of the probability with which an object is recognized as such. No boundary surfaces 13 are shown in FIG. 1.

A second neural network detects the first object group 101 and the second object group 102 and assigns them a boundary surface 21 and 22, respectively. The second neural network assigns the object class CLASS1 to the first object group 101 and the second object group 102.

The second neural network detects the third object group 103, but assigns only one boundary surface 23 to it and assigns the object class CLASS2.

A third neural network detects the first object group 101 and the second object group 102 and assigns them an interface 31 and an interface 32, respectively. The second neural network assigns the object class CLASS1 to the first object group 101 and the second object group 2.

The third neural network does not detect the third object group 103. No interfaces 33 are shown in FIG. 1.

In the embodiment discussed here, the user can select the first default value as a maximum of three, because three neural networks are used in the example discussed here. The user can select the first default value as two (generally v1≥n/2) in order to obtain a majority confirmation of the results from the neural networks.

A detected object is classified as a certain object in the computing unit if the object is assigned to a number of neural networks of the same object class greater than or equal to a predetermined value v≤n and if the object has an IoU value greater than or equal to a threshold value. Otherwise, a detected object is classified as an uncertainly detected object.

The classification of the detected object groups 101, 102, 103 shows that object groups 101 and 102 are recognized by all three neural networks. Object groups 101 and 102 are therefore classified as certain objects. The three neural networks thus enable reliable recognition of object groups containing a car.

The classification of the detected object groups 101, 102, 103 further shows that object group 103 is only recognized by the second neural network. Object group 103 is therefore classified as an uncertain object in the computing unit. Regardless of this, the first neural network and the second neural network are unsuitable for detecting traffic signs. These statements are made on the assumption that the IoU values do not exceed the threshold value in each case.

The suitability of the third neural network for detecting traffic signs is unclear.

Regarding FIG. 2:

FIG. 2 illustrates a reproduction of the data created according to the above description via object recognition by different neural networks to create human-machine interaction.

To create a representation according to FIG. 2, the at least one image must be analyzed using at least three different neural networks.

An n-fold polynomial is displayed on a display unit, where n=1, 2, 3... corresponds to the number of neural networks used to analyze the image. FIG. 2 shows a triangle as a closed triple polygon. The objects detected by an nth neural network are displayed on an nth segment of the polygon on the display unit.

FIG. 2 shows the interfaces 11, 12, 13 recognized by the first neural network for the detected object groups 101, 102, 103 on the first segment of the triangle. As explained in the above description, the first neural network does not recognize object group 103 with sufficient probability. For this reason, the circle is entered with a dashed line at boundary surface 13.

The boundaries 21, 22, 23 of the object groups 101, 102, 103 recognized using the second neural network are plotted on the second side of the triangle. Since, according to the above description of FIG. 1, all object groups are recognized using the second neural network, all circles on the second side are represented by a solid line.

The boundary surfaces 31, 32, 33 of the object groups 101, 102, 103 detected using the third neural network are plotted on the third side of the triangle. Since, according to the above description of FIG. 1, object groups 101 and 102 are detected, the circles for boundary surfaces 31 and 32 are plotted continuously. No circle is plotted for boundary surface 33, since the third object group 103 is not detected by the third neural network.

Objects with a number of lines greater than or equal to the first default value v1 are displayed. FIG. 2 shows the representation for v2=2.

The relationships between the individual objects and the connections between the neural networks are displayed to the user viewing the display device.

By displaying a number of lines greater than or equal to the specified value, the objects are marked in particular by the lines connecting these objects, which objects are recognized by a sufficient number of neural networks and to which objects a correct object class is assigned by a sufficient number of neural networks.

The object groups recognized with sufficient probability by two neural networks are connected by solid lines. When an object is detected and assigned to an object class by all neural networks, the lines form a geometric shape similar to a polygon, in this case a triangle. The number of corners of the geometric shape indicates to the user how many neural networks have recognized the object.

The object groups recognized by a neural network with insufficient probability are connected by dashed lines.

The connections and thus analogies between the neural networks are determined and displayed. FIG. 2 shows an analogy between the first neural network and the second neural network, as these networks recognize all object groups.

The shape of the line (dashed or solid) depends on the number of neural networks through which the object is detected.

The user can select at least one object from the displayed objects via an input unit. The user can also select a line in the same way as selecting an object.

By selecting an object, the user confirms the suitability of the neural networks that recognize the selected object for detecting the object and assigning an object class to this object. The display described above and illustrated in FIG. 2 illustrates the technical content, which object group 101, 102, 103 are recognized by which neural networks. Furthermore, neural networks that deliver corresponding results are shown. In particular, the extent of the corresponding results is illustrated by the number of lines connecting the sides of the polygon.

Based on this technical information, the user can confirm or reject the suitability of the neural networks by selecting the objects.

### Reference Numbers:

11 Interface of the first object group from the first neural network

12 Interface of the first object group from the second neural network

13 Interface of the first object group from the third neural network

21 Interface of the second object group from the first neural network

22 Interface of the second object group from the second neural network

23 Interface of the second object group from the third neural network

31 Interface of the third object group from the first neural network

32 Interface of the third object group from the second neural network

33 Interface of the third object group from the third neural network

101 first object group

102 second object group

103 third object group

104 car driving toward camera

105 car approaching camera

106 road sign

107 headlight

108 wheel of 104

109 rear light

110 wheel of 105

111 external shape of 106

112 symbol in 106

201 collision object

202 image

203 lane

204 observation area

205 line-by-line analysis

206 central axis

207 marking

208 starting point

209 boundary lines

210 vehicle

211 railway track

212 direction of travel

213 camera

214 camera axis

215 rails

216 additional rails

217 concrete slab edges

218 person in the observation area

219 person

220 gap

221 first line

222 second line

223 third line

224 fourth line

225 first direction

226 second direction

227 third direction

228 fourth direction

229 soccer ball

230 additional object

231 interface

1. A method of classifying objects detected with n (n=2,3…) artificial neural networks in at least one image either as a reliably detected object or as an unreliably detected object,
wherein objects contained in the image are detected using a computing unit applying n neural networks, and
each detected object is assigned to a defined object class or an undefined object class,
wherein an IoU value is created for each object selected and detected with each neural network,
wherein:
a detected object is classified as a confident object with the computing unit,
if the object is assigned to the same defined object class with a number of neural networks greater than or equal to a first default value and which object has an IoU value greater than or equal to a threshold value, or
the computing unit classifies a detected object as an uncertain object if the object is assigned to the same defined object class with a number of neural networks less than a first preset value, or
the object is assigned to an undefined object class with a number of neural networks greater than or equal to a second default value, which object has an IoU value less than a threshold value, wherein the first default value and the second default value are less than or equal to the number of neural networks.

2. The method according to claim 1, wherein objects of a single image are detected using neural networks.

3. The method according to claim 1, wherein objects are detected in several images or in several image sections of an image, wherein the images or image sections comprise at least one object of an object class.

4. The method according to claim 3, wherein an object position of the object is determined in one image and the objects with a similar object position are determined in the other images.

5. The method according to claim 1, wherein an object class comprises only a single detected object after assignment of an object by a neural network.

6. The method according to claim 1, wherein the certain objects and/or the uncertain objects from the set of detected objects in the image are displayed in a display unit.

7. The method according to claim 5, wherein:
the certain objects and their object position in the image, and/or
the uncertain objects and their object position in the image are displayed.

8. The method according to claim 1, wherein:
objects in the at least one image are detected using at least three neural networks, whereby links are created between objects of the same known object class detected using different neural networks,
the number of links between the individual neural networks is determined, and
the suitability of neural networks from the at least three neural networks is indicated by the number of links between the mentioned neural network and the further neural network.

9. The method according to claim 1, wherein:
objects in the at least one image are detected using at least three neural networks,
the objects detected using an nth neural network are displayed on an nth segment of an arc-shaped polygon or an arc on a display unit,
the objects detected using different neural networks and belonging to the same known object class are connected by lines,
the objects are marked with a number of lines greater than or equal to the predetermined value v, and
a user can select the displayed objects via an input unit and thus confirm the suitability of the applied neural networks.

10. The method according to claim 9, wherein the polygon has a closed shape with n sides.
